(19) United States
(12) Patent Application Publication
(10) Pub. No.: US 2010/0204987 A1
(43) Pub. Date: Aug. 12, 2010

(54) In-vehicle speech recognition device

(75) Inventor: Hideo Miyauchi, Obu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/658,145

(22) Filed: Feb. 3, 2010

(30) Foreign Application Priority Data
Feb. 10, 2009 (JP) 2009-028960

(51) Int. Cl. G10L 15/00

(52) U.S. Cl. 704/233; 704/E15.001

(57) ABSTRACT

A speech recognition device is disclosed. The device obtains sound of speech of a user and an image of a lip shape of the user. The device determines whether a sudden noise is generated during user speaking. When it is determined that a sudden noise is not generated, the device recognizes content of the speech based on the sound of the speech. When it is determined that a sudden noise is generated, the device recognize the content of the speech based on the image of the lip shape of the user.

### CROSS REFERENCE TO RELATED APPLICATION

The present application is based on Japanese Patent Application No. 2009-28960 filed on Feb. 10, 2009, disclosure of which is incorporated herein by reference.

### BACKGROUND OF THE INVENTION

1. Field of the Invention

The prevent invention relates to an in-vehicle speech recognition device configured to recognize content of speech and adapted for, for example, an in-vehicle audio apparatus.

2. Description of Related Art

JP-2008-213822A corresponding to US-2008/0188271A discloses an in-vehicle handsfree apparatus having a road noise reduction function. The in-vehicle handsfree apparatus is mounted to a vehicle and obtains a noise spectral pattern corresponding to a road surface on which the vehicle is traveling. The in-vehicle handsfree apparatus generates a noise cancellation signal based on a reversed-phase noise spectral pattern, and superimposes the noise cancellation signal on a speech signal representing sound of speech of a conversation partner, and causes a speaker to output the sound of speech.

JP-2000-68882A discloses a cellular phone having a lip-reading function. The cellular phone extracts speech data corresponding to a lip shape of the user from database based on an image of the lip shape, and transmits a word message corresponding to the extracted speech data to a conversation partner.

The inventor of the present application has found that conventional techniques involve the following difficulties. According to a technique described in JP-2008-213822A corresponding to US-2008/0188271A, the noise cancellation signal is superimposed on a speech signal representing the sound of a conversation partner, and then, the sound of speech is outputted from a speaker. Thus, it is possible to facilitate user understating of the speech of a conversation partner. However, if a sudden noise is, superimposed on the sound of speech, the superimposing of the noise cancellation signal cannot remove the sudden noise from the sound of speech, and a user may have a difficulty in understanding the speech. In the above, the sudden noise is instantaneously generable when a conversation partner speaks the speech. It should be noted that the sudden noise is different from a stationary noise such as road noise and the like.

According to a technique described in JP-2000-68882, content of the speech is specified and recognized based on a captured image of a lip shape of the user. Thus, even when the stationary noise and the sudden noise are superimposed on the sound of speech, its influence on speech recognition performance is small. However, since the sounds pronounced with the same lip shape can be different from each other depending on whether the sound is spoken with or without vocal cord vibration (i.e., voiced sound or unvoiced sound), the technique described in JP-2000-68882 has a difficulty in distinguishing whether the sounds are associated with the vocal cord vibration or not. It is thus difficult to specify a sound of the speech, and as a result, the speech recognition performance may be worsened.

### SUMMARY OF THE INVENTION

In view of the above and other difficulties, it is an objective of the present invention to provide a speech recognition device that can accurately recognize content of speech.

According to an aspect of the present invention, there is provided a speech recognition device coupled with an imaging device for capturing an image of a lip shape of a user speaking speech. The in-vehicle speech recognition device includes a sound receiver, a stationary noise reduction section, a first recognition section, a second recognition section, a sudden noise determination section and a control section. The sound receiver is configured to receive sound of the speech. The stationary noise reduction section is configured to reduce a stationary noise in the sound based on a spectral pattern of the stationary noise, the stationary noise being constantly generable and superimposable on the sound. The first recognition section is configured to perform a first speech recognition operation to recognize content of the speech, the first speech recognition operation being performed based on the sound of the speech having the reduced stationary noise. The second recognition section is configured to perform a second speech recognition operation to recognize the content of the speech, the second speech recognition operation being performed based on the image captured by the imaging device. The sudden noise determination section is configured to determine whether a sudden noise is generated during the speaking, the sudden noise being superimposable on the sound of the speech. The control section is configured to cause the first recognition section to perform the first speech recognition operation when the sudden noise determination section determines that the sudden noise is not generated. The control section is further configured to cause the second recognition section to perform the second speech recognition operation when the sudden noise determination section determines that the sudden noise is generated.

According to the above speech recognition device, it is possible to reduce the stationary noise superimposed on the sound of the speech based on the spectral pattern. Thus, when it is determined that the sudden noise is not generated, the first recognition section, which is capable of recognizing the content of the speech regardless of whether the speech is spoken with or without vocal cord vibration, is used to recognize the content of the speech. It is therefore possible to improve speech recognition performance when it is determined that a sudden noise is not generated. When a sudden noise is generated, it is difficult for the stationary noise reduction section to reduce the sudden noise superimposed on the sound of the speech based on the spectral pattern. Thus, when it is determined that a sudden noise is generated, the second recognition section, which is capable of recognizing the content of the speech even if a sudden noise is superimposed on the sound of the speech, recognizes the content of the speech. It is therefore possible to improve speech recognition performance when it is determined that a sudden noise is generated. Through the above manners, it is possible to improve speech recognition performance.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating an in-vehicle speech recognition device in accordance with one embodiment; and

FIG. 2 is a flowchart illustrating a speech recognition procedure performed by an in-vehicle speech recognition device in accordance with one embodiment.

### DETAILED DESCRIPTION OF THE EXEMPLARY EMBODIMENTS

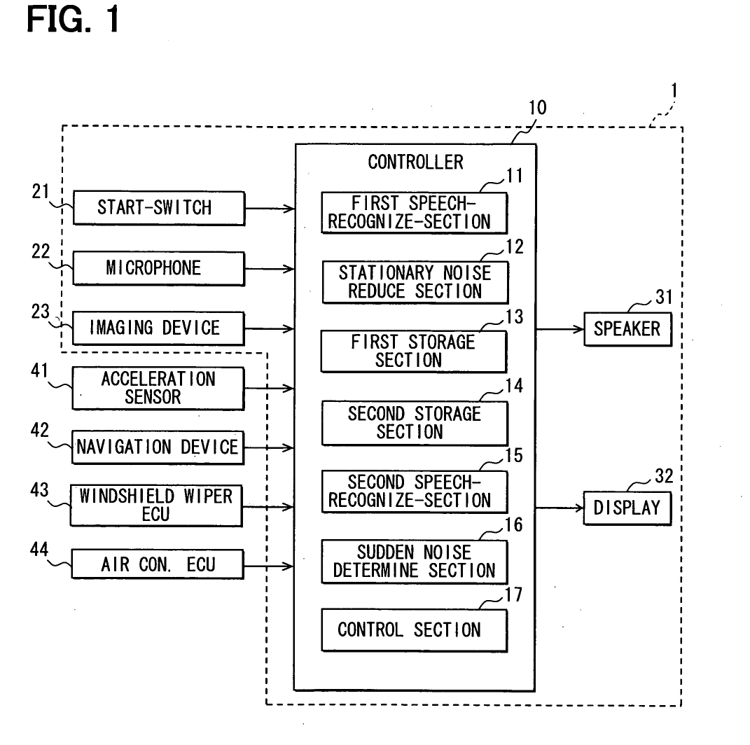

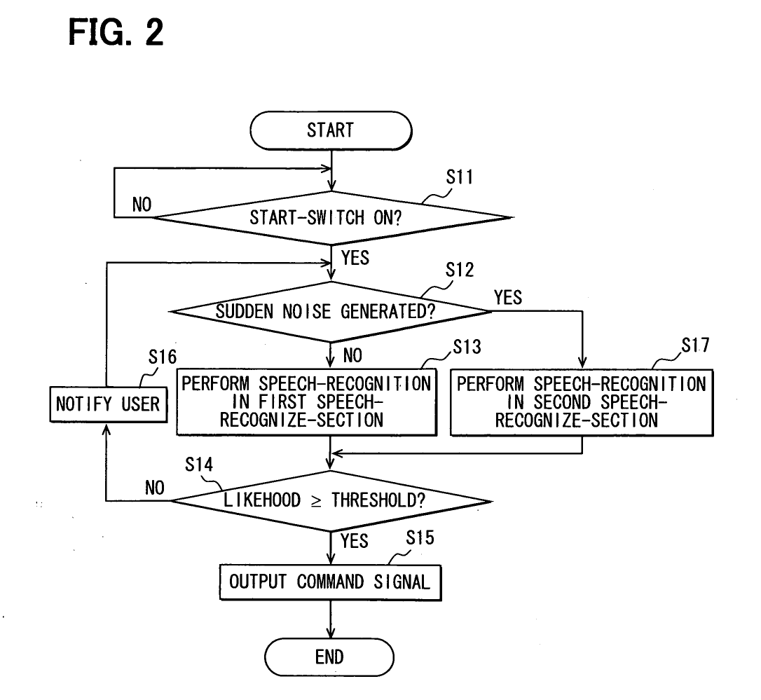

An in-vehicle speech recognition device 1 according to one embodiment is described below with reference to FIGS. 1 and 2. In one embodiment, the in-vehicle speech recognition device 1 is implemented as a part of an in-vehicle audio apparatus.

As shown in FIG. 1, the in-vehicle speech recognition device 1 includes a controller 10, a speech recognition start switch 21, a microphone 22, an imaging device 23, a speaker 31 and a display part 32. The in-vehicle speech recognition device 1 is mounted to a vehicle, and is connected with an acceleration sensor 41, an in-vehicle navigation device 42, a windshield wiper electronic control unit (ECU) 43 of a windshield wiper apparatus and an air conditioner ECU 44 of an air conditioner, any of which is mounted to the subject vehicle.

The speech recognition start switch 21 is connected with the controller 10 and can be used for starting execution of a speech recognition procedure, which will be later described with reference to FIG. 2. When a user performs an operation of switching on the speech recognition start switch 21, the speech recognition start switch 21 transmits a signal indicative of the switching of the speech recognition start switch 21 to the controller 10. When the operation of switching the speech recognition start switch 21 is performed during the execution of the speech recognition procedure, the controller 10 stops the execution of the speech recognition procedure and restarts the speech recognition procedure from the beginning.

The microphone 22 is connected with the controller 10 and is located in a vehicle compartment. When the operation of switching the speech recognition start switch 21 is performed, the microphone 22 starts receiving sound. The sound received with the microphone 22 can include sound of user speech, which may be spoken to issue a command directed to the in-vehicle audio apparatus. A speech signal, which may contain the sound of user speech, is outputted to the controller 10. The microphone 22 acts as a sound receiver.

The imaging device 23 is connected with the controller 10 and placed so that the imaging device 23 can capture an image of a lip shape of a user. When the operation of switching the speech recognition start switch 21 is performed, the imaging device 23 starts capturing an image of a lip shape of a user, and outputs information on the captured image to the controller 10.

The speaker 31 is connected with the controller 10 and is placed so that a variety of information outputted from the speaker 31 reaches a user. For example, the speaker 31 may be mounted to an instrument panel, a ceiling of the vehicle compartment, a front door of the subject vehicle or the like. When the speaker 31 receives notification information from the controller 10, the speaker 31 outputs the notification information in the form of sound based on the notification information. The speaker 31 can act as a notifier.

The display part 32 is connected with a control section 17 and placed so that the display part 32 can display a variety of information in a viewable manner for a user. When the display part 32 receives notification information from the controller 10, the display part 32 displays the notification information on a screen in the form of, for example, image or word. The display part 32 can act as a notifier.

The acceleration sensor 41 is mounted to the subject vehicle and detects acceleration of a traveling direction of the subject vehicle. The acceleration sensor 41 is connected with the controller 10 via, for example, an in-vehicle LAN. When the acceleration sensor 41 detects the acceleration of the subject vehicle, the acceleration sensor 41 outputs information on the detected acceleration to the controller 10.

The navigation device 42 detects the present location of the subject vehicle based on a GPS signal from GPS satellites and map data stored in a storage medium. The navigation device 42 guides a user to a destination, which may be specified by a user. The navigation device 42 is connected with the controller 10 via, for example, an in-vehicle LAN, and transmits information on the present location of the subject vehicle to the controller 10, more particularly to a stationary noise reduction section 12 of the controller 10.

The windshield wiper ECU 43 is a component of a windshield wiper apparatus (not shown), which performs a clearing operation on a windshield of the subject vehicle. The windshield wiper ECU 43 is connected with the controller 10 via, for example, an in-vehicle LAN. When the windshield wiper apparatus performs a cleaning operation, a sudden noise may be generated due to movement of a wiper blade. To the controller 10, the windshield wiper ECU 43 transmits information on timing of performing a cleaning operation, in other words, information on timing of sudden noise generation. The information on timing of performing a cleaning operation is also referred to hereinafter as timing information.

The air conditioner ECU 44 is a component of an air conditioner (not shown), which performs air-conditioning of air in the vehicle compartment of the subject vehicle. The air conditioner ECU 44 is connected with the controller 10 via, for example, an in-vehicle LAN. When the air conditioner performs an air-conditioning operation, a sudden noise may be generated due to the blowing out of air through an air outlet. To the controller 10, the air conditioner ECU 44 transmits information on timing of blowing out the air through the air outlet, in other words, information on timing of sudden noise generation. The information on timing of blowing out the air is also referred to hereinafter as timing information.

The controller 10 includes a microcomputer having therein a CPU, a ROM, a RAM, an I/O and a bus line connecting the foregoing components. In one embodiment, when the controller 10 executes a program stored in the ROM, the controller 10 can have various functions. In one embodiment, the controller 10 may include or may be programmed to act as a first recognition section 11, a stationary noise reduction section 12, a first storage section 13, a second storage section 14, a second recognition section 15, and a sudden noise determination section 16 and a control section 17.

The first storage section 13 is connected with the first recognition section 11 and the stationary noise reduction section 12. The first storage section 13 includes, for example, an Erasable and Programmable Read Only Memory (EEPROM), and stores therein multiple commands directed to the in-vehicle audio apparatus. The first storage section 13 further stores therein multiple sound patterns so that the multiple sound patterns are related to the multiple command. Such information stored in the first storage section 13 is referenced by the first recognition section 11 during the speech recognition procedure. In an in-vehicle environment for instance, stationary noise is constantly generable and superimposable on the sound of user speech. The first storage section 13 further stores therein multiple spectral patterns of stationary noise so that the multiple spectral patterns are related to locations of the subject vehicle. The spectral pattern is read by the stationary noise reduction section 12 when a stationary noise reduction operation is performed. In the followings, the spectral pattern of stationary noise may be also referred to as a noise spectral pattern.

The stationary noise reduction section 12 is connected with the first recognition section 11, the first storage section 13, the microphone 22 and the navigation device 42. The stationary noise is typically superimposed on the speech signal, which may contain the sound of speech. The speech signal is inputted to the stationary noise reduction section 12 from the microphone 22. The stationary noise reduction section 12 obtains information on the present location of the subject vehicle and reads the noise spectral pattern corresponding to the present location of the subject vehicle from the first storage section 13. The stationary noise reduction section 12 performs phase inversion of the noise spectral pattern and adds the inversed-phase noise spectral pattern to the speech signal, thereby reducing the stationary noise superimposed on the speech signal. The stationary noise reduction section 12 outputs the stationary-noise-reduced speech signal, which can represent the sound of the speech having the reduced stationary noise, to the first recognition section 11.

The first recognition section 11 is connected with the stationary noise reduction section 12 and the first storage section 13. The first recognition section 11 is configured to perform a first speech recognition operation to recognize content of user speech based on the stationary-noise-reduced speech signal. For example, the first recognition section 11 obtains the stationary-noise-reduced speech signal from the stationary noise reduction section 12 and extracts a command corresponding to the stationary-noise-reduced speech signal from the first storage section 13. More specifically, the first recognition section 11 extracts one sound pattern from among the multiple, sound patterns stored in the first storage section 13, the one sound pattern having, among the multiple sound patterns, a largest likehood for the sound of the speech having the reduced stationary noise. The first recognition section 11 outputs the extracted sound pattern and the likehood to the control section 17.

The second storage section 14 is connected with the second recognition section 15 and includes, for example, for example, an EEPROM. The second storage section 14 stores therein multiple commands directed to the in-vehicle audio apparatus. The second storage section 14 further stores therein multiple image patterns so that the multiple image patterns are related to the multiple commands. Such information stored in the second storage section 14 is referenced by the second recognition section 15 during the speech recognition procedure. The second storage section 14 further stores therein information on locations of bumps on roads, which bumps can cause sudden noise generation when a vehicle travels through the bumps. The information on locations of bumps is referenced by the sudden noise determination section 16 when it is determined whether a sudden noise is generated during user speaking.

The second recognition section 15 is connected with the imaging device 23, the second storage section 14 and the control section 17. The second recognition section 15 is configured to perform a second speech recognition operation to recognize content of user speech based on an image of a lip shape of user. For example, the second recognition section 15 obtains the image of a lip shape of a user from the imaging device 23 and extracts an image pattern corresponding to the image from the second storage section 14. More specifically, the second recognition section 15 extracts one image pattern from the multiple image patterns stored in the second storage section 14, the one image pattern having a largest likehood for the obtained image among the multiple image patterns. The second recognition section 15 outputs the extracted image pattern and the likehood corresponding to the extracted image pattern to the control section 17.

The sudden noise determination section 16 is connected with the second storage section 14, the control section 17, the microphone 22, the acceleration sensor 41, the navigation device 42, the windshield wiper ECU 43 and the air conditioner ECU 44. The sudden noise determination section 16 determines whether a sudden noise is generated. In the above, the sudden noise is generable during the user speaking and superimposable on the sound of the user speech. When it is determined that the sudden noise is generated, the sudden noise determination section 16 transmits a signal indicative of the generation of the sudden noise to the control section 17.

The sudden noise determination section 16 obtains the speech signal from the microphone 22. Based on amplitude and frequency of a signal component of the speech signal, the sudden noise determination section 16 determines whether a user is speaking. When it is determined that a user is speaking, the sudden noise determination section 16 determines whether a sudden noise is generated.

When a vehicle passes through a bump on a road such as a pothole on a road and the like, a sudden noise, which may influence speech recognition performance of the first recognition section 11, may generate. When the vehicle passes through a bump, the acceleration of the vehicle can greatly vary and can be outside a predetermined acceleration range. In view of the above acceleration characteristics, the in-vehicle speech recognition device 1 performs the following operations. When it is determined that a user is speaking, the sudden noise determination section 16 determines whether the acceleration detected by the acceleration sensor 41 is outside the predetermined acceleration range. When it is determined that the acceleration is outside the predetermined acceleration range, the sudden noise determination section 16 determines that the sudden noise is generated.

In typical cases, the locations of bumps on roads are fixed. Thus, when it is determined that a user is speaking, the sudden noise determination section 16 determines whether the subject vehicle passes through a bump of a road, based on (i) the present location of the subject vehicle detected by the navigation device 42 and (ii) the information on the locations of bumps stored in the second storage section 14. When it is determined that the subject vehicle passes through a bump on a road, the sudden noise determination section 16 determines that a sudden noise is generated. In the present disclosure, the location of a fixed bump on a road is an example of a predetermined location. The predetermined location may be a location where the sudden noise that can influence speech recognition performance of the first recognition section 11 is frequency generated when a vehicle passes through the predetermined location.

Further, in typical cases, when the windshield wiper apparatus mounted to the subject vehicle performs a cleaning operation, a sudden noise may generate due to movement of a wiper blade. Thus, when it is determined that a user is speaking, the sudden noise determination section 16 determines whether a cleaning operation is performed by the windshield wiper apparatus, based on the timing information inputted from the windshield wiper ECU 43. When it is determined that a cleaning operation is performed by the windshield wiper apparatus during the user speaking, it is determined that a sudden noise is generated.

Further, in typical cases, when an air conditioning operation is performed by the air conditioner mounted to the subject vehicle, a sudden noise may generate due to the blowing out of air through an air outlet. Thus, when it is determined that a user is speaking, the sudden noise determination section 16 determines whether an air conditioning operation is performed by the air conditioner mounted to the subject vehicle, based on the timing information inputted from the air conditioner ECU 44. When it is determined that an air conditioning operation is performed by the air conditioner during the user speaking, the sudden noise determination section 16 determines that a sudden noise is generated.

The control section 17 is connected with the speech recognition start switch 21, the sudden noise determination section 16, the first recognition section 11, the second recognition section 15, the speaker 31 and the display part 32.

When a signal indicating that the operation of switching the speech recognition start switch 21 is performed is inputted from the speech recognition start switch 21 to the control section 17, the control section 17 causes the first recognition section 11 to perform the first speech recognition operation and obtain a sound pattern and a likehood associated with the sound pattern. When the sound pattern and the likehood are inputted to the control section 17, the control section 17 determines whether the likehood is greater than or equal to a predetermined likehood threshold. When it is determined that the likehood is greater than or equal to the predetermined likehood threshold, the control section 17 issues a command corresponding to the sound pattern to the in-vehicle audio apparatus. When it is determined that the likehood is less than the predetermined likehood threshold, the control section 17 (i) causes the speaker 31 to output the sound indicating that the likehood is less than the predetermined likehood threshold, (ii) causes the display part 32 to display information indicating that the likehood is less than the predetermined likehood threshold, and (iii) causes the first recognition section 11 to automatically re-perform the first speech recognition operation.

When the sudden noise determination section 16 determines that a sudden noise is generated during the first speech recognition operation of the first recognition section 11, the control section 17 causes the second recognition section 15 to perform the second speech recognition operation to obtain an image pattern and a likehood associated with the image pattern. When the image pattern and the likehood are inputted to the control section 17, the control section 17 determines whether the likehood is greater than or equal to a predetermined likehood threshold. When it is determined that the likehood is greater than or equal to the predetermined likehood threshold, the control section 17 issues a command corresponding to the image pattern to the in-vehicle audio apparatus. When it is determined that the likehood is less than the predetermined likehood threshold, the control section 17 (i) causes the speaker 31 to output the sound indicating that the likehood is less than the predetermined likehood threshold, (ii) causes the display part 32 to display information indicating that the likehood is less than the predetermined likehood threshold, and (iii) causes the second recognition section 15 to automatically re-perform the second speech recognition operation.

Operation of the in-vehicle speech recognition device 1 is described below with reference to FIG. 2. FIG. 2 is a flowchart illustrating a speech recognition procedure S1, which the in-vehicle speech recognition device 1 executes.

When the speech recognition procedure S1 is started, the control section 17 determines at S11 whether an operation of switching the speech recognition start switch 21 is performed. When it is determined that the operation of switching the speech recognition start switch 21 is not performed, corresponding to “NO” at S11, the control section 17 performs S11 again. In other words, without the speech recognition being performed, the process waits until the operation of switching the speech recognition start switch 21 is performed. When it is determined that the operation of switching the speech recognition start switch 21 is performed, corresponding to “YES” at S11, the process proceeds to S12.

For simplicity, FIG. 2 describes that, when the operation of switching the speech recognition start switch 21 is detected, the control section 17 performs S12, and the control section 17 then performs S13 or S17 depending on a determination result at S12. However, when the operation of switching on the speech recognition start switch 21 is detected, the control section 17 may actually perform S12 in a timely manner while performing S13, and the process may proceed to S17 when the determination “YES” is made at S12.

More specifically, when the operation of switching the speech recognition start switch 21 is detected, the control section 17 causes at S13 the first recognition section 11 to perform the first speech recognition operation to recognize content of user speech, and determines at S14 whether the likehood associated with the sound pattern extracted by the first recognition section 11 is greater than or equal to the predetermined likehood threshold.

When it is determined that the likehood associated with the sound pattern is greater than or equal to the predetermined likehood threshold, corresponding to “YES” at S14, the process proceeds to S15. At S15, the control section 17 issues, to the in-vehicle audio apparatus, a command corresponding to the sound pattern extracted at S13.

When it is determined that the likehood associated with the sound pattern is less than the predetermined likehood threshold, corresponding to “NO” at S14, the control section 17 causes at S16 the speaker 31 and the display part 32 to provide information indicating that the likehood is less than the predetermined likehood threshold. Further, the control section 17 causes the first recognition section 11 to automatically re-perform the first speech recognition operation, even when the operation of switching the speech recognition start switch 21 is not performed.

When it is determined that the likehood associated with the image pattern is greater than or equal to the predetermined likehood threshold, corresponding to “YES” at S14, the control section 17 issue at S17 a command corresponding to the image pattern extracted at S17 to the in-vehicle audio apparatus. When it is determined that the likehood associated with the image pattern is less than the predetermined likehood threshold, corresponding to “NO” at S14, the Control section 17 causes at S16 to the speaker and the display part 32 to provide the information indicating that the likehood associated with the image pattern is less than the predetermined likehood threshold. Further, the control section 17 causes the second recognition section 15 to automatically re-perform the second speech recognition operation, even if the operation of switching the speech recognition start switch 21 is not performed.

As described above, in one embodiment, when the sudden noise determination section 16 determines that a sudden noise is not generated, the control section 17 causes the first recognition section 11 to perform the first speech recognition operation. When the sudden noise determination section 16 determines that a sudden noise is generated, the control section 17 causes the second recognition section 15 to perform the second speech recognition operation. Since the first recognition section 11, which is capable of recognizing content of user speech regardless of the presence or absence of vocal cord vibration, is used to recognize the content of user speech when a sudden noise generation is generated, it is possible to improve the speech recognition performance. Further, since the second recognition section 15, which is capable of recognizing content of user speech even when the sudden noise is superimposed on the sound of use speech, is used to recognize content of user speech when a sudden noise is generated, it is possible to improve the speech recognition performance. Accordingly, it is possible to improve the speech recognition performance.

In the above, the predetermined acceleration range may be a range of accelerations that causes generation of a sudden noise that does not substantially influence the speech recognition performance of the first recognition section 11. In some cases, even when a vehicle passes through a bump and a resultant acceleration causes generation of a sudden noise, the resultant acceleration is within the predetermined, range and the generated sudden noise does not substantially influence the speech recognition performance of the first recognition section 11. In the above, the speech recognition performance of the first recognition section 11 may be expressed as a ratio of (i) a number of times a likehood obtained in the first speech recognition operation exceeds a predetermined likehood threshold to (ii) a total number of times the first speech recognition operation is performed. The speech recognition performance of the second recognition section 11 may be expressed in a similar way.

The above embodiment can be modified in various ways, examples of which are described below.

In the above described embodiment, the sudden noise determination section 16 determines whether a sudden noise is generated, based on whether the acceleration detected by the acceleration sensor 41 mounted to the subject vehicle is outside the predetermined acceleration range. Alternatively, the navigation device 42 mounted to the subject vehicle may include an acceleration sensor 41. In this configuration, the sudden noise determination section 16 may determine whether a sudden noise is generated, based on whether the acceleration detected by the acceleration sensor 41 of the navigation device 42 is outside a predetermined acceleration range. Alternatively, a user may bring a portable device capable of detecting acceleration and the in-vehicle speech recognition device 1 may includes a first communication section that is communicatable with the portable device. In this configuration, the sudden noise determination section 16 may determine whether a sudden noise is generated, based on whether the sudden noise determination section 16 receives information from the portable device via the first communication section, the information indicating that acceleration detected by the portable device is outside a predetermined acceleration range. In the above, the first, communication section may be a Bluetooth (registered trademark) communication section. Alternatively, the in-vehicle speech recognition device 1 may include an acceleration sensor 41. In this configuration, the sudden noise determination section 16 may determines whether a sudden is generated, based on whether the acceleration detected by the acceleration sensor 41 of the in-vehicle speech recognition device 1 is outside the predetermined acceleration range. In other words, as long as the in-vehicle speech recognition device 1 can obtain information on acceleration, a device for providing the information on acceleration may not be limited to a particular device.

In the above described embodiment, the second storage section 14 stores therein information on locations of bumps on roads that can cause sudden nose generation when the subject vehicle passes through the bumps. Alternatively, the information on locations of bumps on roads may be stored in a storage other than the second storage section 14. For example, a built-in storage (not shown) of the navigation device 42 may store therein the information on locations of bumps on roads. Alternatively, a portable device, which may be carried by a user, includes a storage that stores therein the information on locations of bumps on roads. Further, the in-vehicle speech recognition device 1 may include a first communication section (e.g., a Bluetooth communication section), which is communicatable with the portable device. Alternatively, the in-vehicle speech recognition device 1 may include a second communication section (e.g., a public line communication section), and the information on locations of bumps on roads may be stored in a storage of a server. Alternatively, the in-vehicle speech recognition device 1 includes a first communication section (e.g., a Bluetooth communication section) communicatable with a portable device having a storage. Further, via the portable device, the in-vehicle speech recognition device 1 may communicate with a server that has a storage storing therein the information on locations of bumps on roads. In other words, as long as the sudden noise determination section 16 can obtain the information on locations of bumps on roads, a storage for storing therein the information on locations of bumps on roads may not limited to a particular storage. It should be noted that when a storage of a server stores therein the information on locations of bumps, the in-vehicle speech recognition device 1 may use information from a vehicle other than the subject vehicle.

In the above described embodiment, the sudden noise determination section 16 determines whether a sudden noise is generated, based on the followings: an output of the acceleration sensor 41; the present location of the subject vehicle detected by the navigation device 42; an operational state of the windshield wiper apparatus; and an operational state of the air conditioner.

The subject vehicle may be further equipped with an inter-vehicle communication apparatus for two-way communication between the subject vehicle and a vehicle other than the subject vehicle. In this configuration, when the inter-vehicle communication apparatus receives a signal indicating that a peripheral vehicle other than the subject vehicle passes by the subject vehicle, the sudden noise determination section 16 may determine that a sudden noise is generated. The above configuration takes into consideration a case where a sudden noise such as engine sound and exhaust sound of the periphery vehicle is generated when the peripheral vehicle passes by the subject vehicle.

Alternatively, the sudden noise determination section 16 may determine that a sudden noise is generated, when frequency of the sound, which is received with the microphone 22 and may contain the sound of user speech, is less than or equal to a predetermined frequency threshold (e.g., 10 Hz). It should be noted that the inventor of the present application has confirmed that, when a vehicle passes through a bump on a road, a sudden nose having frequency of about 10 Hz or less is typically generated.

Alternatively, the sudden noise determination section 16 may determine that a sudden noise is generated, when the amplitude of the sound, which is received with the microphone 22 and may contain the sound of user speech, is outside a predetermined amplitude range. Further, while the first recognition section 11 is recognizing content of user speech, the control section 17 may record the amplitude of the sound received with the microphone 22 in the first storage section 13. The sudden noise determination section 16 may set the predetermined amplitude range based on information on the amplitude stored in the first storage section 13.

Alternatively, the sudden noise determination section 16 may determine that a sudden noise is generated, when an averaged power of the sound (which may include the sound of user speech) received with the microphone 22 is outside a predetermined power range. Further, while the first recognition, section 11 is recognizing content of user speech, the control section 17 may record the averaged power in the first storage section 13. The sudden noise determination section 16 may set the predetermined power range based on information on the averaged power stored in the first storage section 13.

Alternatively, the sudden noise determination section 16 may determine that a sudden noise is generated, when the duration of reception of the sound (which may include the sound of user speech) in the microphone 22 is less than or equal to a predetermined duration threshold (e.g.; 100 ms). The inventor of the present application has confirmed that a typical duration of speech for issuing a command to the in-vehicle audio apparatus is longer than 100 ms.

The above-described predetermined frequency threshold, the above-described predetermined amplitude range, the above-described predetermined power range, the above-described duration threshold can be set on a vehicle-type basis in view of sound insulation properties of the subject vehicle, quietness properties of the subject vehicle, acoustic properties of a vehicle compartment, or damping or spring proprieties of a suspension of the subject vehicle.

Alternatively, based on volume and frequency band of daily-life user-speech, a portable device may set and store the above-described predetermined frequency threshold, the above-described predetermined amplitude range, the above-described predetermined power range in a storage. By using the above threshold or range, the sudden noise determination section 16 may determine whether a sudden noise is generated.

In the above described embodiment, the second recognition section 15 performs the second speech recognition operation, in which content of user speech is recognized based on the image captured by the imaging device 23. However a device for capturing the image is not limited to the imaging device 23. For example, the in-vehicle speech recognition device 1 may include an imaging device 23 for capturing an image of a lip shape of a user, and the second recognition section 15 may perform the second speech recognition operation based on the image captured by the imaging device 23 of the in-vehicle speech recognition device 1. Alternatively, a portable device having an imaging device 23, which is capable of imaging a lip shape of a user, may be carried by a user, and the in-vehicle speech recognition device 1 may include a first communication section communicatable with the portable device. In such a case, the second recognition section 15 may recognize content of user speech based on information on the image received via the first communication section. In the above, the first communication section and the portable device may transmit therebetween the information via wired communication or wireless communication. When the first communication section 11 and the portable device transmit therebetween the information via wireless communication, it is possible to employ any communication method or system such as Bluetooth and the like.

In the above described embodiment, when the control section 17 determines that the subject vehicle passes through a bump on a road during the user speaking and during the first speech recognition operation of the first recognition section 11, the control section 17 causes the second recognition section 15 to perform the second speech recognition operation. In the above, if a bumpy section further continues in the road, there may arise a case where a likehood associated with an image pattern is lower than a predetermined likehood threshold even when the second recognition section 15 performs the second speech recognition operation to recognize the content of use speech. In view of the above case, if a bumpy section continues in the road, the control section 17 may cause the speaker 31 and the display part 32 to output information that encourages a user to start speaking after the subject vehicle passes through the bumpy section.

In the above embodiment, when it is determined that a likehood associated with a sound pattern is lower than a predetermined likehood threshold, the control section 17 causes the first recognition section 11 to automatically re-perform the first speech recognition operation. Alternatively, the in-vehicle speech recognition device 1 may be configured such that: when it is determined that a likehood associated with a sound pattern is lower than a predetermined likehood threshold, the speech recognition procedure S1 is ended and the first recognition section 11 does not automatically re-perform the first speech recognition operation. When the speech recognition procedure S1 is ended without the re-performing of the first speech recognition operation, the control section 17 may re-perform the speech recognition procedure S1 in response to the operation of switching the speech recognition start switch 21. When a likehood associated with a sound pattern is successively determined to be lower than a predetermined likehood a predetermine number of times (e.g., three times), the control section 17 may cause the second recognition section 15 to perform the second speech recognition operation regardless of whether a sudden noise is generated during the user speaking.

In the above described embodiment, when it is determined that a likehood associated with an image pattern is lower than a predetermined likehood threshold, the control section 17 causes the second recognition section 15 to automatically re-perform the second speech recognition operation. Alternatively, when it is determined that a likehood associated with an image pattern is lower than a predetermined likehood threshold, the second recognition section 15 may not automatically re-perform the second speech recognition operation and the speech recognition procedure S1 may be ended.

In the above described embodiment, the control section 17 causes the second recognition section 15 to perform the second speech recognition operation when it is determined that a sudden noise is generated during the user speaking and during the first speech recognition operation of the first recognition section 11. When the subject vehicle travels at high speeds, the performance of stationary noise reduction of the stationary noise reduction section 12 may be worsened, and as a result, the speech recognition performance of the first recognition section 11 may be worsened. In view of the above possible situation, the control section 17 may obtain speed of the subject vehicle from the speed sensor equipped with, for example, the subject vehicle. When the speed of the subject vehicle is greater than or equal to a predetermined speed threshold (e.g., 80 km/h), the control section 17 may cause the second recognition section 15 to perform the second speech recognition operation. In this alternative configuration, even if the performance of stationary noise reduction is worsened, it is possible to recognize content of user speech by using the second recognition section 15.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

What is claimed is:

1. An in-vehicle speech recognition device coupled with an imaging device for capturing an image of a lip shape of a user speaking speech, the in-vehicle speech recognition device comprising:
a sound receiver that is configured to receive sound of the speech;
a stationary noise reduction section that is configured to reduce a stationary noise in the sound based on a spectral pattern of the stationary noise, the stationary noise being constantly generable and superimposable on the sound;
a first recognition section that is configured to perform a first speech recognition operation to recognize content of the speech based on the sound of the speech having the reduced stationary noise;
a second recognition section that is configured to perform a second speech recognition operation to recognize the content of the speech based on the image captured by the imaging device;
a sudden noise determination section that is configured to determine whether a sudden noise is generated during the speaking, the sudden noise being superimposable on the sound of the speech; and
a control section that is configured to:
cause the first recognition section to perform the first speech recognition operation when the sudden noise determination section determines that the sudden noise is not generated; and
cause the second recognition section to perform the second speech recognition operation when the sudden noise determination section determines that the sudden noise is generated.

2. The in-vehicle speech recognition device according to claim 1, the in-vehicle speech recognition device being further coupled with an acceleration sensor mounted to a vehicle,
wherein:
the sudden noise determination section determines whether the sudden noise is generated, based on whether an acceleration detected by the acceleration sensor during the speaking is outside a predetermined acceleration range; and
when the acceleration detected by the acceleration sensor during the speaking is outside the predetermined acceleration range, the sudden noise determination section determines that the sudden noise is generated.

3. The in-vehicle speech recognition device according to claim 1, the in-vehicle speech recognition device being further coupled with a navigation device mounted to a vehicle,
wherein:
the sudden noise determination section determines whether the sudden noise is generated, based on whether the navigation device detects that the vehicle passes through a predetermined location during the speaking; and
when the navigation device detects that the vehicle passes through the predetermined location during the speaking, the sudden noise determination section determines that the sudden noise is generated.

4. The in-vehicle speech recognition device according to claim 1, the in-vehicle speech recognition device being further coupled with a wiper apparatus mounted to a vehicle,
wherein:
the sudden noise determination section determines whether the sudden noise is generated, based on whether the wiper apparatus performs a cleaning operation during the speaking; and
when the wiper apparatus performs the cleaning operation during the speaking, the sudden noise determination section determines that the sudden noise is generated.

5. The in-vehicle speech recognition device according to claim 1, the in-vehicle speech recognition device being further coupled with an air conditioner mounted to a vehicle,
wherein:
the sudden noise determination section determines whether the sudden noise is generated, based on whether the air conditioner performs an air conditioning operation during the speaking; and
when the air conditioner performs the air conditioning operation during the speaking, the sudden noise determination section determines that the sudden noise is generated.

6. The in-vehicle speech recognition device according to claim 1, the in-vehicle speech recognition device being further coupled with an inter-vehicle communication apparatus (i) mounted to a subject vehicle, (ii) configured to perform inter-vehicle communication between the subject vehicle and a peripheral vehicle, and (iii) configured to provide information indicting whether the peripheral vehicle passes by the subject vehicle,
wherein:
the sudden noise determination section determines whether the sudden noise is generated, based on whether the peripheral vehicle passes by the subject vehicle; and
when the sudden noise determination section receives the information indicating that the peripheral vehicle passes by the subject vehicle, the sudden noise determination section determines that the sudden noise is generated.

7. The in-vehicle speech recognition device according to claim 1, wherein the imaging device is a component of a portable device, the in-vehicle speech recognition device further comprising:
a communication section that is communicatable with the portable device so that information on the image is transmittable between the communication section and the portable device,
wherein:
the second recognition section performs the second speech recognition operation based on the information on the image received via the communication section.

8. The in-vehicle speech recognition device according to claim 1, further comprising:
a storage section that is configured to store therein information on a plurality of sound patterns,
wherein:
the first recognition section performs the first speech recognition operation through extracting one sound pattern from the plurality of sound patterns, the one sound pattern having, among the plurality of sound patterns, a largest likehood for the sound of the speech having the reduced stationary noise.

9. The in-vehicle speech recognition device according to claim 1, further comprising:
a storage section that is configured to store therein information on a plurality of image patterns that respectively corresponds to a plurality of sound patterns of the user;
the second recognition section performs the second speech recognition operation through extracting one image pattern from the plurality of image patterns, the one image pattern having, among the plurality of image patterns, a largest likehood for the captured image of the lip shape of the user.

10. The in-vehicle speech recognition device according to claim 8, further comprising:
a notifier,
wherein:
when the largest likehood for the sound of the speech having the reduced stationary noise is smaller than the predetermined likehood threshold, the control section causes the notifier to notify the user that the largest likehood for the sound is smaller than the predetermined likehood threshold, thereby encouraging the user to again speak the speech.

11. The in-vehicle speech recognition device according to claim 10, wherein:
when the largest likehood for the sound is smaller than the predetermined likehood threshold, the control section causes the first recognition section to automatically re-perform the first speech recognition operation.
